(19) United States
(12) Patent Application Publication
(10) Pub. No.: US 2004/0046283 A1
(43) Pub. Date: Mar. 11, 2004

(54) Method of producing a roll boot

(76) Inventor: Herbert Cermak, Bessenbach (DE)

Correspondence Address: Robert P. Renke, Suite 250, 28333 Telegraph Road, Southfield, MI, 48034, US

(21) Appl. No.: 10/614,456

(22) Filed: Jul. 7, 2003

(30) Foreign Application Priority Data
Jul. 10, 2002 (DE) 102 31 075.0

(51) Int. Cl. B29C 31/00; B29C 45/00

(52) U.S. Cl. 264/294; 264/328.2

(57) ABSTRACT

A method of producing a roll boot from an injection-moldable elastomer, comprising the following steps: injection-molding a basic member having a cylindrical portion and a widened portion; turning the basic member inside out; folding the widened portion outwardly so that it partially comes to lie outwards of the cylindrical portion, forming a roll wall.

### TECHNICAL FIELD

The invention relates to a method of producing roll boots from an injection-moldable elastomer.

### BACKGROUND OF THE INVENTION

Elastomer roll boots are primarily used for sealing two parts which can be articulated relative to one another and which, more particularly, rotate at the same time. A typical application refers to sealing constant velocity universal joints. For this purpose, a cylindrical portion with a smaller diameter is slipped on to a shaft connected to a first joint component, and an annular bead with a greater diameter is connected either directly or via an intermediate element to a second joint component. Between the cylindrical portion mentioned first and the annular bead with the greater diameter, there extends a roll wall which, as a rule, has the shape of half a torus. When the two joint components carry out an articulation movement relative to one another, the radius of curvature of the roll wall decreases on the inside of the angle and increases on the outside of the angle. When the joint rotates in the articulated condition, the change in curvature in the roll boot wall moves across the circumference, so that during a complete 360° rotation, each point of the roll boot wall passes through a curvature maximum and a curvature minimum. This results in intense internal flexing work which can lead to an increase in the temperature in the roll boot and to damage.

Prior art roll boots, already in their starting condition, have production-related positive tensile stresses in the region of the roll boot wall, so that when the roll boot rotates in an articulated condition, the stresses periodically fluctuate around the starting value, i.e. more particularly, they are periodically clearly increased beyond the starting value. This leads to close load application limits of the roll boot in respect of permissible angles and/or permissible rotational speed.

### SUMMARY OF THE INVENTION

It is therefore an object of the present invention to provide a process of producing roll boots, which process leads to roll boots with a higher load bearing capacity.

A first solution provides a method of producing a roll boot from an injection-moldable elastomer, comprising the following process stages: injection-molding a basic member having a cylindrical portion and a widened portion; turning the basic member inside out; and folding the widened portion outwardly so that it partially comes to lie outwards of the cylindrical portion, forming a roll wall.

There is thus produced a roll boot of the initially mentioned type with a cylindrical portion for being fixed to a shaft and with a curved roll wall which is in the shape of half a torus and whose free ends can be provided with a bead for being fixed to a second component. In the starting condition, in the critical zone of the roll boot fold, the roll boot produced in this way comprises substantially fewer stresses than a roll boot of the same shape produced according to the state of the art. The critical zone of the roll boot fold is the apex line of the curved roll wall in the shape of half a torus. The product of the process as specified thus has the same shape as roll boots according to the state of the art, but differs therefrom with respect to its internal stress conditions. The invention thus also covers the product produced by the inventive process. No further reference will be made to the definition of the product in connection with its internal stress conditions.

A second solution in accordance with the invention provides a method of producing a roll boot from an injection-moldable elastomer, comprising the following process stages: injection-molding a basic member having a cylindrical portion and two widened portions which adjoin the cylindrical portion at both ends; turning the basic member inside out; and folding the widened portions outwardly, so that they partially come to lie outwards of the cylindrical portion, forming roll walls.

According to this method, there is produced a type of roll boot which is not described above and which comprises a cylindrical intermediate portion and two roll walls which are in the shape of half a torus and which each comprise fixing beads at their free ends, which fixing beads can each be connected to two different rotational parts which can be articulated relative to one another and/or axially displaced relative to one another. Because of the double roll wall design, roll boots of this type are suitable for longer axial displacement paths and increased angles of articulation. The above-mentioned changes in the diameter of curvature of the roll wall and thus the periodic changes in the stress conditions in the roll wall, in this case, too, occur in both roll walls. However, because the load is distributed to two roll walls, with a predetermined angle and a predetermined rotational speed, the load is smaller, and a roll boot of this type can optionally accommodate greater angular movements. In this case, too, it is not only the process for producing a roll boot which is new, but also the product itself in respect of its stress conditions, i.e. while the outer shape remains unchanged, the product comprises a changed internal stress structure. However, no further reference is made to the direct definition of the stress structure; the product is defined via the production process.

According to an advantageous embodiment, at least one of the widened portions is injection-molded to achieve an approximately conical basic shape, and the widened portion is injection-molded so as to comprise a wall thickness which decreases from the cylindrical portion to its respective free ends. The shape of the widened portions facilitates production and is advantageous from the point of view of achieving a uniform load application. Furthermore, the cylindrical portion can be injection-molded so as to comprise, at its free end, an inner annular groove for receiving a clamping band, and at least one of the widened portions is injection-molded so as to comprise inner annular beads at its free end. As a result of the basic member being turned inside out, the annular groove comes to be positioned on the outside. Initially, as a result of the basic member being turned inside out, the annular beads come to be positioned on the outside, and due to the subsequent folding operation, they return to the inside, pointing towards the cylindrical portion.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

In the drawings, preferred embodiments of the invention are compared to the state of the art and will be described below:

FIG. 1 shows a roll boot in accordance with the state of the art:

a) in a longitudinal section after having been injection-molded,

b) in a longitudinal section, after having been folded into the shape which is ready to use.

FIG. 2 shows a roll boot according to the invention in a first embodiment:

a) in a longitudinal section after having been injection-molded;

b) in a semi-section after having been folded in accordance with the invention; and

c) in a semi-section after having been folded into the shape which is ready to use.

FIG. 3 shows a roll boot in accordance with the invention in a second embodiment:

a) in a longitudinal section after having been injection-molded;

b) in a semi-section after having been folded in accordance with the invention; and

c) after having been folded into the shape which is ready to use.

FIG. 4 shows a longitudinal sectional view of an inventive roll boot in an exemplary constant velocity joint assembly.

### DETAILED DESCRIPTION

In all Figures, there are given stress conditions in the wall of the roll boot in the form of bar values relative to a zero line, with tensile stresses being given in the form of positive values and compressive stresses in the form of negative values. The direction of the positive values is indicated by an arrow extending perpendicularly relative to the zero line, with the direction of the negative values extending in the direction opposite to the arrow.

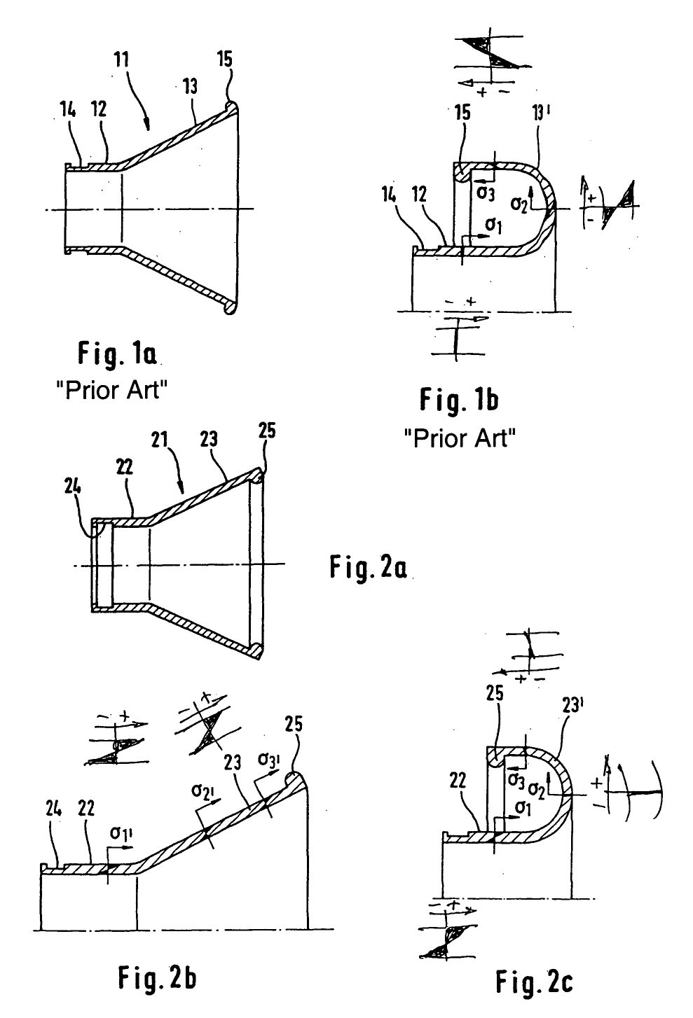

FIG. 1a shows a roll boot 11 according to the state of the art in a longitudinal section. The roll boot 11 is first injection-molded from an injection-moldable elastomer into a shape which comprises a cylindrical portion 12 and a conically widening widened portion 13. In this shape, the member is stress-free. Subsequently, the cylindrical portion 12 serves to secure the roll boot on a shaft and comprises an outer annular groove 14 which, for securing purposes, can be engaged by a tensioning strip. The widened portion 13, at its free end, comprises a bead 15 which can be gripped by a beading of a fixing sleeve which can be connected to a part which is angularly movable relative to the shaft. In the region of the cylindrical portion 12, the wall thickness of the basic member is substantially constant. The wall thickness of the widened portion decreases from the cylindrical portion to the free end.

FIG. 1b shows the roll boot according to the state of the art in a configuration which is ready for use, with the widened portion being folded back over the unchanged cylindrical portion 12 and now forming a roll wall portion 13′ in the shape of half a torus. Whereas the annular groove 14 continues to be positioned on the outside of the cylindrical portion, the bead 15 now points radially inwardly. Because of the accumulation of material at the annular bead, the annular bead substantially retains its original diameter, whereas in the boot wall of the roll wall portion 13′, there occur stress conditions which are illustrated by stress profiles in some selected cross-sections. In the region of the unchanged cylindrical portion, the stress σ₁ equals zero, i.e. the wall is stress-free. In the apex of the roll wall region 13′, the stress σ₂ reaches its maximum. In the vicinity of the bead 15, the stress σ₃ is lower again, but it definitely differs from zero. On the inside of the curvature, there prevails a compressive stress and on the outside there exists a tensile stress of approximately the same value.

FIG. 2a shows an inventive roll boot 21 in a finish-injection-molded shape comprising a cylindrical portion 22 and a widened portion 23 of a conical shape. In this shape, the member is stress-free. The cylindrical portion, in principle, serves to be secured on a shaft, whereas the widened portion is later deformed into a roll wall portion. The inside of the cylindrical portion is provided with an annular groove 24 which, later, serves to receive a tensioning strip. At the widened portion 23, there is formed an inwardly pointing annular bead 25 which, later, is received by a beading of a fixing sleeve.

FIG. 2b shows a semi-section of an inventive roll boot after the turning operation wherein the previous outside becomes the inside and the previous inside becomes the outside. The annular groove 24 of the cylindrical portion 22 is now positioned on the outside, as specified. The widened portion has a purely conical shape. As a result of the change in shape as mentioned, stresses have already occurred in the boot wall. A stress σ_{1′} in the region of the cylindrical portion deviates from zero just like the stresses σ_{2′}, σ_{3′} in the region of the widened portion. On the outside of the member, there are tensile stresses and on the inside of the member, there are compressive stresses. As the cylindrical portion during subsequent use is not subjected to additional deformation, the prevailing stress σ_{1′} can be regarded as uncritical.

FIG. 2c again shows a semi-section of the cylindrical portion 22 in an unchanged condition, whereas the widened portion has now been outwardly folded over to form the roll wall portion 23′ pointing towards the cylindrical portion. The bead 25 is now positioned so as to point radially inwardly. In this case, too, it applies that due to accumulation of material, the bead 25 substantially retains the same diameter as previously in FIG. 2b, whereas the roll wall 23′ is locally subjected to different changes in shape. This results in a change in stresses. The remaining stress condition σ₁ in the region of the cylindrical portion continues to differ from zero, but is uncritical, as already mentioned. Further remaining stresses σ₂ in the region of the apex of the roll walls 23′ and σ₃ near the bead 25, however, have become zero as a result of the folding-over operation, or are very low as compared to the respective stress condition according to the state of the art in FIG. 1. The additional loads on the roll wall when the roll boot moves in the mounted condition, and more particularly when rotating in an articulated position, have become uncritical as a result.

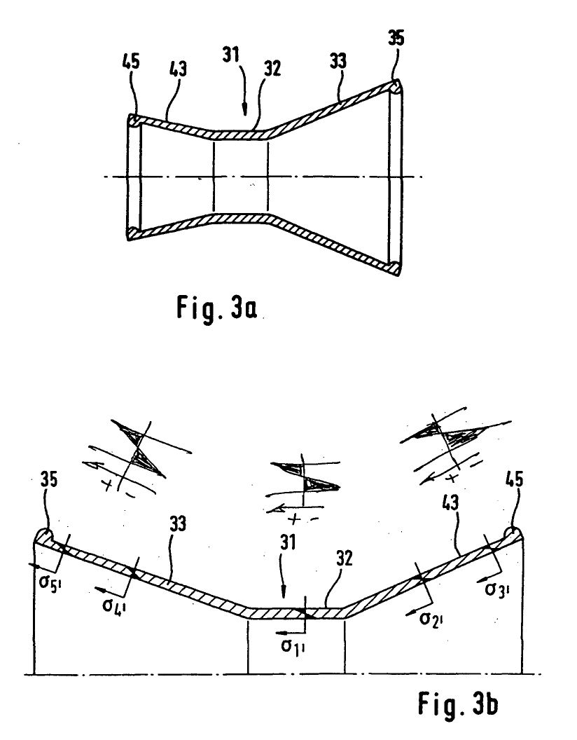

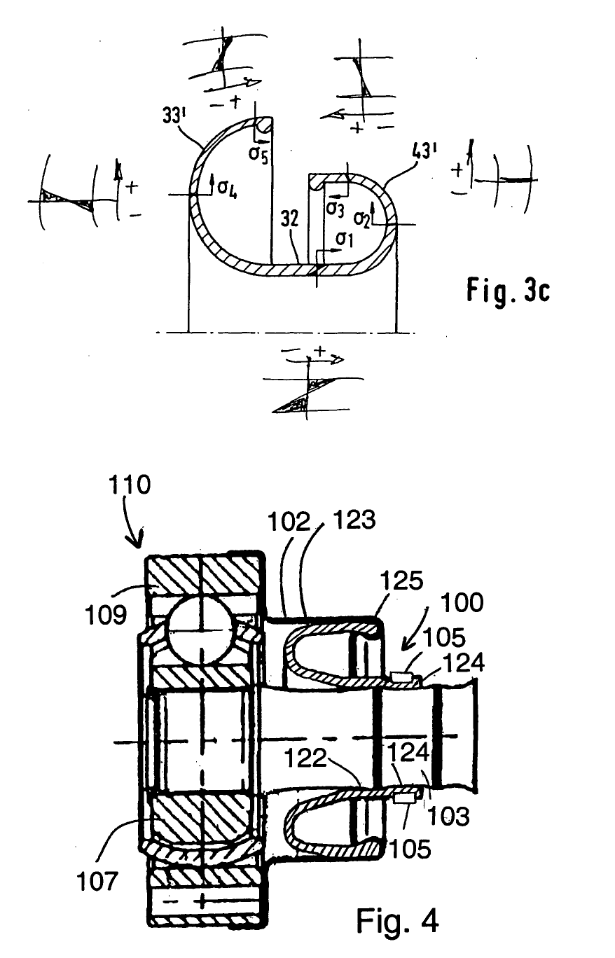

FIG. 3a shows an inventive roll boot 31 comprising a cylindrical portion 32 and two conically shaped widened portions 33,43. In this shape, the member is stress-free. The cylindrical portion can be used for centering purposes on a shaft without being secured thereto, whereas the widened portions are later deformed into roll wall portions. The widened portions 33, 43 are each provided with an inwardly pointing annular bead 35,45 which is later received by a beading of a fixing sleeve.

In FIG. 3b, the semi-section shows the inventive roll boot after the turning operation, wherein the previous outside becomes the inside and the previous inside becomes the outside. The beads 35,45 of the widened portions 33, 43 point outwardly. The widened portions have a purely conical shape. Because of the above-mentioned change in shape, stresses have already occurred in the boot wall. The stress σ_{1′}, in the region of the cylindrical portion deviates from zero just like the stresses σ_{2′}, σ_{3′} in the region of the widened portion. On the outside of the member, there are tensile stresses and on the inside of the member, there are compressive stresses. As the cylindrical portion, during subsequent use, is not subjected to additional deformation, the prevailing stress σ_{1′} can be regarded as uncritical.

FIG. 3c again shows a semi-section of the cylindrical portion 32 in an unchanged condition, whereas the widened portions have now been outwardly folded over to form the roll wall portions 33′,43′ pointing towards the cylindrical portion. The beads 35,45 are now positioned so as to point radially inwardly. In this case, too, it applies that due to accumulation of material, the beads 35, 45 substantially retain the same diameter as previously in FIG. 3b, whereas the roll walls 33′ are locally subjected to different changes in shape. This results in a change in stresses. The remaining stress condition σ₁ in the region of the cylindrical portion continues to differ from zero, but is uncritical, as already mentioned. Further remaining stresses σ₂, σ₄ in the region of the apices of the roll walls 33′,43′ and σ₃, σ₅ near the beads 35,45, however, have become zero as a result of the folding-over operation, or are very low as compared to the respective stress condition according to the state of the art in FIG. 1. The additional loads on the roll wall when the roll boot moves in the mounted condition, and more particularly when rotating in an articulated position, have become uncritical as a result.

Thus, the method of producing the roll boots of FIGS. 2 and 3 includes the steps of injection-molding a basic member having a cylindrical portion and at least one conical or widened portion, turning the basic member inside out, and folding the widened portion outwards so that it comes to lie towards the cylindrical portion and thereby forms the roll wall of the boot.

FIG. 4 shows a longitudinal sectional view of an inventive boot in an exemplary constant velocity joint assembly. The roll boot 100 is fixed at the annular bead 125 of the widened portion 123 to a cover 102, and at the annular groove 124 of the cylindrical portion 122 to a shaft 103. A clamp band 105 seated in the annular groove 124 secures the boot 100 to the shaft 103. The shaft 103 is connected to the inner joint part 107 of the constant velocity joint 110. The cover 102 is connected to the outer joint part 109. Thus, the roll boot 100 seals the joint 110 at the shaft end. Of course, a roll boot according to the present invention could also be used to seal numerous other constant velocity joint configurations. The joint of FIG. 4 is thus shown only as one example of an application of a roll boot according to the present invention.

While the invention has been described in connection with several embodiments, it should be understood that the invention is not limited to those embodiments. Thus, the invention covers all alternatives, modifications, and equivalents as may be included in the spirit and scope of the appended claims.

What is claimed is:

1. A method of producing a roll boot from an injection-moldable elastomer, comprising the following steps:
injection-molding a basic member (21) having a cylindrical portion (22) and an widened portion (23);
turning the basic member (21) inside out; and
folding the widened portion (23) outwardly so that it partially lies outwards of the cylindrical portion (22), forming a roll wall (23′).

2. A method of producing a roll boot from an injection-moldable elastomer, comprising the following steps:
injection-molding a basic member (31) having a cylindrical portion (32) and two widened portions (33, 43) which adjoin said cylindrical portion (32) at both ends;
turning the basic member (31) inside out; and
folding the widened portions (33, 43) outwardly, so that they partially lie outwards of the cylindrical portion (32), forming roll walls (33′, 43′).

3. A method according to claim 1, wherein the widened portion (23) is injection-molded to have an approximately conical shape.

4. A method according to claim 2, wherein the widened portions (33, 43) are injection-molded to have an approximately conical shape.

5. A method according to claim 1, wherein the widened portion (23) is injection-molded to comprise a wall thickness which decreases from the cylindrical portion (22) to its free end.

6. A method according to claim 2, wherein the widened portions (33, 43) are injection-molded to comprise a wall thickness which decreases from the cylindrical portion (32) to their respective free ends.

7. A method according to claim 1, wherein the cylindrical portion (22) is injection-molded to comprise, at its free end, an inner annular groove (24) for receiving a clamping band.

8. A method according to claim 3, wherein the cylindrical portion (22) is injection-molded to comprise, at its free end, an inner annular groove (24) for receiving a clamping band.

9. A method according to claim 5, wherein the cylindrical portion (22) is injection-molded to comprise, at its free end, an inner annular groove (24) for receiving a clamping band.

10. A method according to claim 1, wherein the widened portion (23) is injection-molded to comprise an inner annular bead (25) at its free end.

11. A method according to claim 3, wherein the widened portion (23) is injection-molded to comprise an inner annular bead (25) at its free end.

12. A method according to claim 5, wherein the widened portion (23) is injection-molded to comprise an inner annular bead (25) at its free end.

13. A method according to claim 7, wherein the widened portion (23) is injection-molded to comprise an inner annular bead (25) at its free end.

14. A method according to claim 2, wherein the widened portions (33, 43) are injection-molded to comprise inner annular beads (34, 35) at their respective free ends.

15. A method according to claim 4, wherein the widened portions (33, 43) are injection-molded to comprise inner annular beads (34, 35) at their respective free ends.

16. A method according to claim 6, wherein the widened portions (33, 43) are injection-molded to comprise inner annular beads (34, 35) at their respective free ends.

17. A method of producing a roll boot from an injection-moldable elastomer, comprising the steps of:
injection-molding a basic member (21) having a cylindrical portion (22) and a widened portion (23), the cylindrical portion (22) including, at its free end, an inner annular groove (24) for receiving a clamping band, the widened portion (23) comprising a conical shape, an inner annular bead (25) at is free end, and a decreasing wall thickness from the cylindrical portion (22) to its free end;
turning the basic member inside out such that the annular groove (24) and annular bead (25) are outwardly facing; and
folding the widened portion (23) outwardly so that it partially lies outwards of the cylindrical portion (22), forming a roll wall (23′).

18. A method of producing a roll boot from an injection-moldable elastomer, comprising the steps of:
injection-molding a basic member (31) having a cylindrical portion (32) and two widened end portions (33, 43) adjoining the cylindrical portion, each widened portion (33, 43) comprising a conical shape, an inner annular bead (34, 35) at its free end, and a decreasing wall thickness from the cylindrical portion (32) to its free end;
turning the basic member (31) inside out such that the annular beads (34, 35) are outwardly facing; and
folding the widened portions (33, 43) outwardly so that they partially lie outwards of the cylindrical portion (32), forming roll walls (33′, 43′).

19. A roll boot for a constant velocity joint made according to the method of claim 1.

20. A constant velocity joint comprising a roll boot made according to the method of claim 1.
